(19) United States
(12) Patent Application Publication
(10) Pub. No.: US 2026/0368437 A1
(43) Pub. Date: Nov. 19, 2026

(54) INFORMATION PROCESSING DEVICE, INFORMATION PROCESSING METHOD, AND RECORDING MEDIUM

(71) Applicant: NEC Corporation, Tokyo (JP)

(72) Inventor: Tomohiko WATANABE, Tokyo (JP)

(73) Assignee: NEC Corporation, Tokyo (JP)

(21) Appl. No.: 19/655,924

(22) Filed: Apr. 23, 2026

(30) Foreign Application Priority Data
May 13, 2025 (JP) 2025-080484

(51) Int. Cl. G06F 40/35

(52) U.S. Cl. CPC G06F 40/35

(57) ABSTRACT

In order to visually present, in an easily understandable manner for a user, contents learned by a generative AI in a system utilizing an interactive generative AI, in an information processing device including a generative AI and communicably connected to a terminal device used by the user who engages in dialogue with the generative AI, a processor acquires, from the terminal device, dialogue information relating to dialogue content input by the user. The processor transmits, based on the dialogue information, at least one precondition learned by the generative AI to the terminal device, and causes the terminal device to display the precondition in an area different from an area in which the dialogue content is displayed.

### INCORPORATION BY REFERENCE

This application is based upon and claims the benefit of priority from Japanese Patent Application 2025-080484, filed on May 13, 2025, the disclosure of which is incorporated herein in its entirety by reference.

### TECHNICAL FIELD

The present disclosure relates to a technology that supports a utilization of a generative AI (Artificial Intelligence).

### BACKGROUND ART

In recent years, the utilization of a generative AI has been progressing due to backgrounds such as solving labor shortages and accelerating advanced data utilization. Specifically, systems that utilize a conversational generative AI to obtain results requested by users, such as chat-based customer support, have become familiar. Patent Document 1 describes a training device for constructing machine learning models for tabular data, which displays a progress of upstream task training and model parameters.

Patent Document 1: International Publication Pamphlet No. WO2024/257558

### SUMMARY

In a case of engaging in two-way communication with a conversational generative AI, even if there is a timing to have the generative AI learn a condition that serves as a prerequisite (hereinafter also referred to as a “precondition”) during the dialogue, it is difficult for a user to recognize it. In other words, it is difficult for the user to recognize the precondition learned by the generative AI and a timing of learning. In particular, in a case where the dialogue situation changes, such as across days or between different users, the user needs to review past interactions in order to correctly grasp the preconditions, which can lead to time loss for verification as well as the possibility of overlooking information. Furthermore, in a case where the precondition is changed, it is necessary for the user to provide appropriate instructions each time, which poses the problem of being cumbersome.

One of the objectives of the present disclosure is to provide an information processing device that visually presents, in an easily understandable manner for the user, contents learned by the generative AI in a system utilizing the interactive generative AI.

According to an example aspect of the present invention, there is provided an information processing device including a generative AI and communicably connected to a terminal device used by a user who engages in dialogue with the generative AI, the information processing device including:
at least one memory configured to store instructions; and
at least one processor configured to execute the instructions to:
acquire, from the terminal device, dialogue information relating to dialogue content input by the user; and
transmit, based on the dialogue information, at least one precondition learned by the generative AI to the terminal device, and cause the terminal device to display the precondition in an area different from an area in which the dialogue content is displayed.

According to another example aspect of the present invention, there is provided an information processing method executed by an information processing device comprising a generative AI and communicably connected to a terminal device used by a user who engages in dialogue with the generative AI, the method including:
acquiring, from the terminal device, dialogue information relating to dialogue content input by the user; and
transmitting, based on the dialogue information, at least one precondition learned by the generative AI to the terminal device, and causing the terminal device to display the precondition in an area different from an area in which the dialogue content is displayed.

According to still another example aspect of the present invention, there is provided a non-transitory computer-readable recording medium storing a program executed by a computer of an information processing device including a generative AI and communicably connected to a terminal device used by a user who engages in dialogue with the generative AI, the program causing the computer to perform:
acquiring, from the terminal device, dialogue information relating to dialogue content input by the user; and
transmitting, based on the dialogue information, at least one precondition learned by the generative AI to the terminal device, and causing the terminal device to display the precondition in an area different from an area in which the dialogue content is displayed.

### EFFECT

According to the present disclosure, it is possible to provide an information processing device that visually presents, in an easily understandable manner for a user, contents learned by a generative AI in a system utilizing an interactive generative AI.

### BRIEF DESCRIPTION OF THE DRAWINGS

FIG. 1 is an example of a schematic configuration of a learning content visualization system of the present disclosure.

FIGS. 2A and 2B are block diagrams illustrating examples of hardware configurations of a server and a user terminal.

FIG. 3 is a block diagram illustrating an example of a functional configuration of the server.

FIG. 4 is a diagram illustrating processes performed by the learning content visualization system.

FIGS. 5A and 5B are examples of screens displayed on a user terminal during dialogue with a generative AI.

FIG. 6 is an example of a screen on a different date.

FIG. 7 is an example of a screen where a precondition has been edited.

FIG. 8 is a flowchart illustrating an example of a precondition output process by the server.

FIG. 9 is a flowchart illustrating an example of an answer output process by the server.

FIG. 10 is a flowchart illustrating an example of an editing process by the server.

FIG. 11 is a diagram illustrating a process performed in an open environment.

FIG. 12 is a block diagram illustrating an example of another functional configuration of the information processing device.

FIG. 13 is a flowchart illustrating an example of a process performed by the functional configuration depicted in FIG. 12.

### EXAMPLE EMBODIMENTS

Preferred example embodiments of the present disclosure will be described with reference to the accompanying drawings.

### FIRST EXAMPLE EMBODIMENT

### Overall Configuration

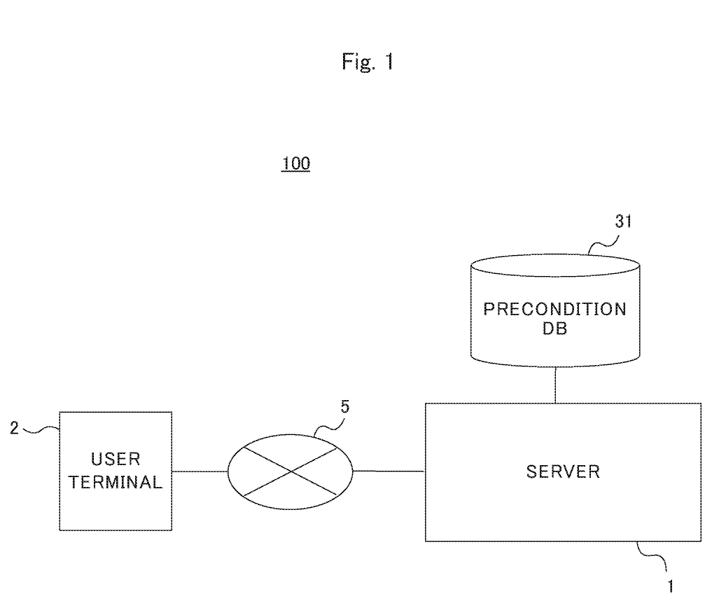

FIG. 1 is an example of a schematic configuration of a learning content visualization system to which the information processing device of the present disclosure is applied. A learning content visualization system 100 is, for instance, a system using a conversational generative AI, such as a chat-based customer support system (hereinafter also simply referred to as a “generative AI”), and is a system that visually presents contents learned by the generative AI in an easily understandable manner to the user.

Specifically, the generative AI is a conversational AI utilizing large language models (LLMs), such as ChatGPT, and may, for instance, be specially trained on domain-specific knowledge such as medical or legal knowledge.

In the learning content visualization system 100 illustrated in FIG. 1, a server 1 and a user terminal 2 are communicably connected via a network 5 such as the Internet. The user is the person who interacts with the conversational generative AI possessed by the server 1 using the user terminal 2 in a text-based chat format. The dialogue between the conversational generative AI and the user is not limited to the text-based chat format; it can be applied to any format, such as one using images or audio, as long as the user terminal 2 has a screen capable of displaying the learned content.

The user terminal 2 is a smartphone, tablet, PC, or the like used by the user, which transmits dialogue information regarding the dialogue content input in the chat-format dialogue to the server 1, and receives and displays answer information regarding the answer by the generative AI and a precondition learned by the generative AI from the server 1. Here, the precondition is information to train the generative AI as a precondition for the dialogue, or information that the generative AI has already learned. The user terminal 2 is an example of a terminal device used by the user of the present disclosure.

The server 1 is an information processing device that performs processing, storage, and transmission/reception of various data, and receives dialogue information from the user terminal 2, and transmits the answer information by the generative AI and the precondition to the user terminal 2. The server 1 is connected to a precondition DB 31, which will be described later. The server 1 may be a virtual server existing in a cloud environment. The server 1 is an example of the information processing device of the present disclosure.

### Hardware Configuration

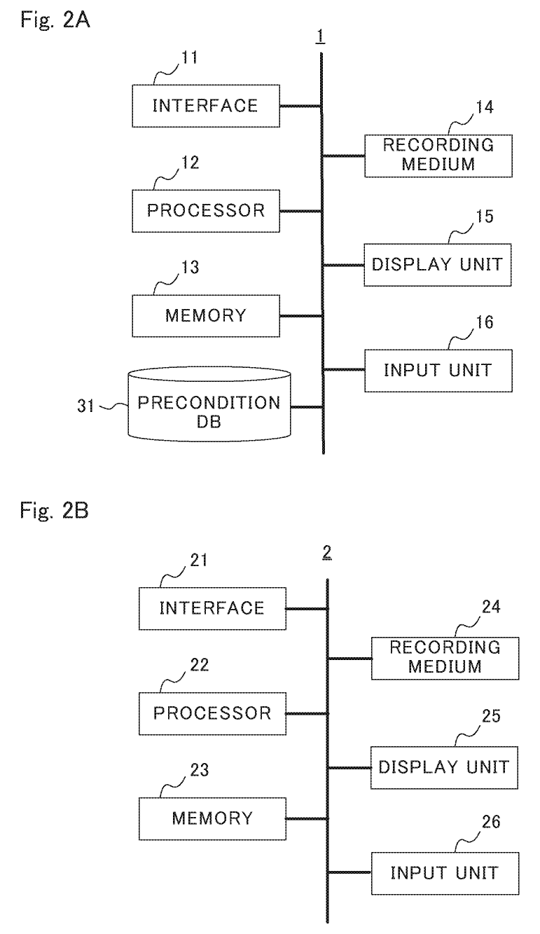

FIG. 2A is a block diagram illustrating an example of the hardware configuration of the server 1. As illustrated, the server 1 includes an interface 11, a processor 12, a memory 13, a recording medium 14, a display unit 15, and an input unit 16. These components and the precondition DB 31 are mutually connected via a bus.

The interface 11 performs data exchange with the user terminal 2. The interface 11 is used in a case of receiving dialogue information from the user terminal 2 or transmitting the answer information and the precondition to the user terminal 2.

The processor 12 is a computing unit that controls the entire server 1 by executing programs prepared in advance. The processor 12 may be, for instance, a CPU (Central Processing Unit), a GPU (Graphics Processing Unit), a DSP (Digital Signal Processor), a MPU (Micro Processing Unit), a FPU (Floating-Point Unit), a PPU (Physics Processing Unit), a TPU (Tensor Processing Unit), a quantum processor, a microcontroller, or any combination thereof.

The memory 13 is composed of components such as a ROM (Read-Only Memory) and a RAM (Random Access Memory). The memory 13 stores programs executed by processor 12. Also, the memory 13 is used as working memory during the execution of various processes by the processor 12.

The recording medium 14 is a non-volatile and non-transitory recording medium, such as a disk-shaped recording medium or a semiconductor memory, and is configured to be detachable from the server 1. The recording medium 14 stores various programs executed by the processor 12. In a case where the server 1 executes a precondition output process, an answer output process, and an editing process, which will be described later, the programs stored in the recording medium 14 are loaded into the memory 13 and executed by the processor 12.

The display unit 15 is, for example, an LCD (Liquid Crystal Display) and displays various images during operations of the server 1. The input unit 16 includes a keyboard, a mouse, touch panel, or the like, and is used by an operator who manages the server 1.

The precondition DB 31 records information learned by the generative AI as the precondition for each dialogue with the user.

FIG. 2B is a block diagram illustrating an example of the hardware configuration of the user terminal 2. As illustrated, the user terminal 2 includes an interface 21, a processor 22, a memory 23, a recording medium 24, a display unit 25, and an input unit 26.

The interface 21 performs data exchange with the server 1 via the network 5. The interface 21 is used in a case of transmitting dialogue information to the server 1 or receiving the answer information and the precondition from the server 1.

The processor 22 is a computer such as a CPU, which controls the entire user terminal by executing programs prepared in advance. Note that, as the processor 22, a CPU, a GPU, a DSP, a MPU, a FPU, a PPU, a TPU, a quantum processor, a microcontroller, or a combination thereof, etc., can be used.

The memory 23 is composed of components such as a ROM, a RAM, or the like. The memory 23 stores the program executed by the processor 22. Also, the memory 23 is sed as a working memory during the execution of various processes by the processor 22.

The recording medium 24 is a non-volatile and non-transitory recording medium such as a disc-shaped recording medium or a semiconductor memory, and is configured to be attachable and detachable to the user terminal 2. The recording medium 24 records various programs executed by the processor 22. The display unit 25 is, for instance, an LCD, and displays various images while the user is operating the user terminal 2. The input unit 26 is a touch panel or the like and is used in a case where the user performs a predetermined operation.

### Functional Configuration

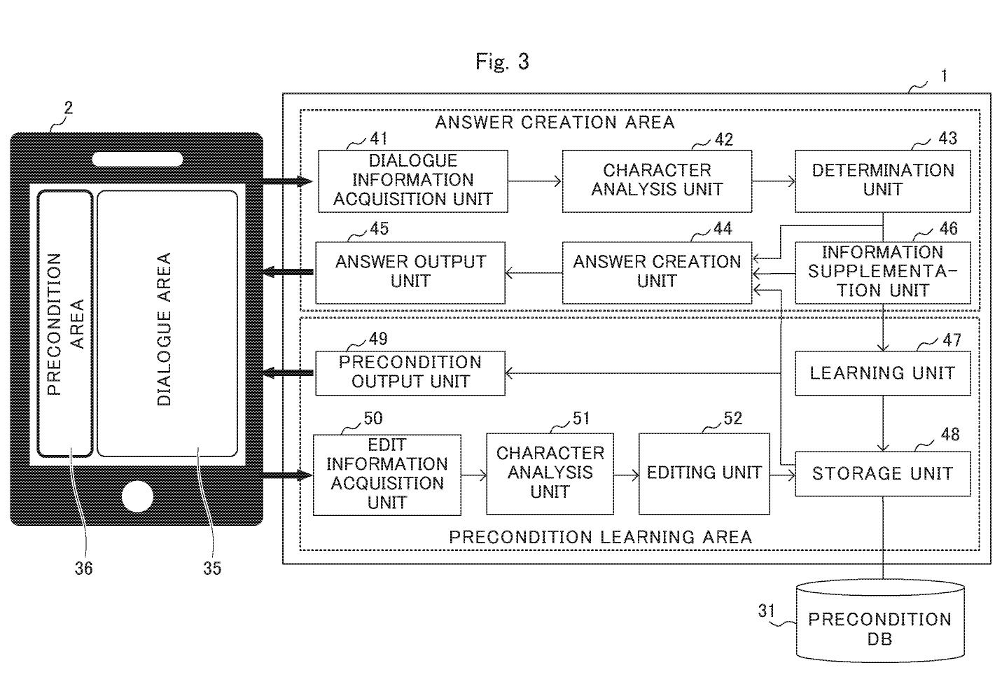

FIG. 3 is a block diagram illustrating an example of the functional configuration of the server 1. Functionally, the server 1 includes a dialogue information acquisition unit 41, a text analysis unit 42, a determination unit 43, an answer creation unit 44, an answer output unit 45, an information supplementation unit 46, a learning unit 47, a storing unit 48, a precondition output unit 49, an edit information acquisition unit 50, a text analysis unit 51, and an editing unit 52.

The answer creation area, which is the area mainly for creating answers, is composed of the dialogue information acquisition unit 41, the text analysis unit 42, the determination unit 43, the answer creation unit 44, the answer output unit 45, and the information supplementation unit 46. Also, the precondition learning area, which is the area mainly for learning the precondition, includes the learning unit 47, the storing unit 48, the precondition output unit 49, the edit information acquisition unit 50, the text analysis unit 51, and the editing unit 52.

The dialogue information acquisition unit 41, the text analysis unit 42, the determination unit 43, the answer creation unit 44, the answer output unit 45, the information supplementation unit 46, the learning unit 47, the storing unit 48, the precondition output unit 49, the edit information acquisition unit 50, the text analysis unit 51, and the editing unit 52 are realized by the processor 12 executing corresponding programs.

As illustrated in FIG. 3, the screen for dialogue with the generative AI on the user terminal 2 is assumed to have a dialogue area 35 for displaying the dialogue content and a precondition area 36 for displaying the precondition. The dialogue area 35 is an area where the user inputs text using the user terminal 2 or displays the answer based on the answer information received from the server 1. The precondition area 36 is an area where the precondition learned by the generative AI through dialogue are displayed in a list, or where the displayed precondition can be edited. To enable the user to check the precondition during the dialogue, it is desirable for the precondition to be displayed in a different area on the same screen as the area displaying the dialogue content, as illustrated in the screen in FIG. 3.

Note that the screen illustrated in FIG. 3 is an example, and the number and configuration of the screens can be arbitrarily set, as long as the precondition can be displayed in an area that the user can easily check during the dialogue.

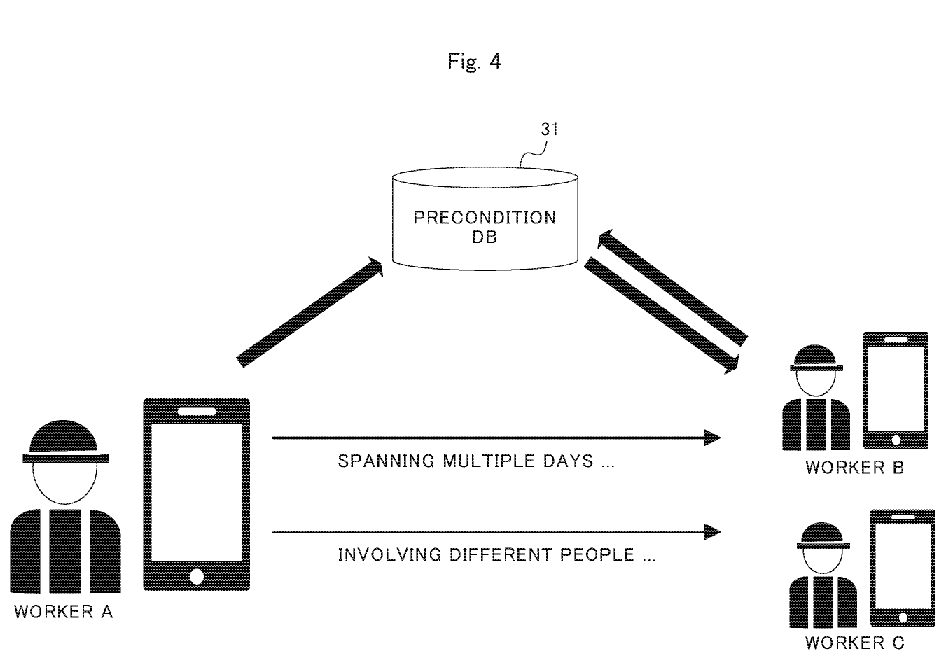

FIG. 4 is a diagram illustrating processes performed by the learning content visualization system 100. As an example, the learning content visualization system 100 is assumed to be a system where multiple workers performing road maintenance tasks can confirm or ask questions about their work through dialogue with the generative AI.

In a case where multiple users utilize the learning content visualization system 100, the screen for dialogue with the generative AI is shared among all users. For instance, as illustrated in FIG. 4, in a case where workers A to C use the system, the screen for each worker to confirm or ask questions regarding road maintenance tasks is shared among all workers A to C. Each time any worker performs dialogue or edits the precondition, the screen is updated, and the workers A to C can view the updated screen on their respective user terminals.

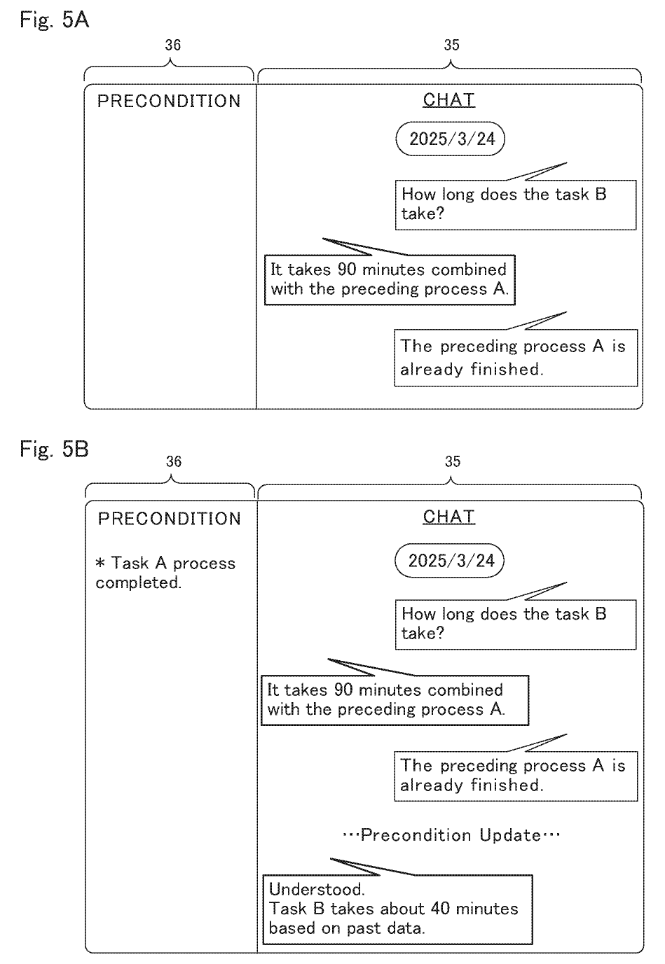

The dialogue information acquisition unit 41 acquires dialogue information regarding the dialogue content input by the user into the dialogue area 35 from the user terminal 2. FIG. 5 is an example of the screen displayed on the user terminal 2 during dialogue with the generative AI. In a case where the worker A, who is the user, inputs the question "How long does the task B take?", the user terminal 2 displays the text "How long does the task B take?" in the dialogue area 35 and transmits that text as dialogue information to the server 1, as illustrated in FIG. 5A. In other words, the dialogue information acquisition unit 41 acquires the text "How long does the task B take?" as dialogue information from the user terminal 2. Note that the dialogue area 35 may display the date and time of the dialogue.

The text analysis unit 42 analyzes the meaning of the dialogue information by analyzing the words, sentence structure, and intent contained in the text.

The determination unit 43 determines, based on an analysis result from the text analysis unit 42, whether dialogue information is information to be learned by the generative AI as the precondition for dialogue with the user. Specifically, the determination unit 43 uses the generative AI to make the determination, considering, for instance, a task content, a time, an environment, and a situation in a case of a road maintenance task. Note that the generative AI used for determination may be the same as the generative AI that dialogues with the user, or may be a different engine or model.

The answer creation unit 44 acquires the dialogue information determined by the determination unit 43 not to be information to train the generative AI. The answer creation unit 44 also acquires the precondition from the precondition DB 31. At this time, the answer creation unit 44 may acquire relevant information related to the dialogue with the user from a predetermined DB storing reliable data or external data, using RAG (Retrieval Augmented Generation) based on the acquired precondition. Next, the answer creation unit 44 uses the generative AI to create an answer for the user based on the acquired dialogue information and the precondition. At this time, the generative AI creates the answer by referring to the relevant information as necessary. For instance, it creates the answer "It takes 90 minutes combined with the preceding process A" to the question "How long does the task B take?" input by the worker A, who is the user.

The answer creation unit 44 may also acquire relevant information using RAG with a prompt generated based on the precondition.

The answer output unit 45 transmits answer information regarding the answer created by the answer creation unit 44 to the user terminal 2 and causes it to be displayed in the dialogue area 35 of the screen. For instance, the user terminal 2 displays the text "It takes 90 minutes combined with the preceding process A" in the dialogue area 35, as illustrated in FIG. 5A.

The information supplementation unit 46 acquires the dialogue information determined by the determination unit 43 to be information to train the generative AI, and supplements the dialogue information. Specifically, the information supplementation unit 46 understands the dialogue information to train the generative AI, compares it with the precondition already stored in the precondition DB 31, and analyzes and organizes how the learning is to be performed. Also, the information supplementation unit 46 also processes the dialogue information so that it can be utilized in RAG or fine-tuning.

Assume that the dialogue information acquisition unit 41 acquired the text "The preceding process A is already finished." illustrated in FIG. 5A as dialogue information, and the determination unit 43 determined that this dialogue information is information to train the generative AI. In this case, the information supplementation unit 46, for instance, refers to the precondition DB 31 considering the task content, the time, the environment, the situation, etc., and changes "The preceding process A is already finished." to "Task A process completed.". At this time, the information supplementation unit 46 may acquire relevant information related to the dialogue with the user from a predetermined DB storing reliable data or external data, using RAG based on a new precondition "Task A process completed.".

Note that the answer creation unit 44 may acquire and utilize the relevant information from the information supplementation unit 46. Also, the information supplementation unit 46 may acquire relevant information using RAG with a prompt generated based on the new precondition.

The learning unit 47 trains the generative AI with the dialogue information supplemented by the information supplementation unit 46 as a precondition. At this time, the generative AI performs learning considering the relevant information as necessary. In other words, the learning unit 47 performs fine-tuning based on the new precondition and relevant information.

The storing unit 48 stores the generative AI model, which has been additionally trained with the new precondition, in the precondition DB 31. By storing and managing the trained model separately from the generative AI engine in this manner, it is possible to take over and utilize the stored trained model even in a case where the engine is changed, for instance. Note that the storing unit 48 is not limited to trained models; it may also store the precondition learned by the generative AI as data in the precondition DB 31.

The precondition output unit 49 transmits information organizing the updated precondition to the user terminal 2 each time the precondition learned by the generative AI are updated, and displays the information in a list in the precondition area 36. Updating the precondition means adding a new precondition or editing an existing precondition. For instance, in the example depicted in FIG. 5B, the user terminal 2 displays the text "Task A process completed" in the precondition area 36 based on the information transmitted by the precondition output unit 49. For convenience of explanation, only the text "Task A process completed" is illustrated in the precondition area 36 in FIG. 5B, but if there are a plurality of preconditions learned by the generative AI, all organized preconditions are displayed in a list so that the user can grasp all of them by viewing the precondition area 36.

Furthermore, in a case where a precondition learned by the generative AI is added, the precondition output unit 49 transmits information to the user terminal 2 indicating that the learning by the generative AI has been updated. In a case where the user terminal 2 receives the information indicating that the learning by the generative AI has been updated, it displays the text "PREREQUISITE CONDITION UPDATE" in the dialogue area 35, as illustrated in FIG. 5B. This enables the timing at which the generative AI learned the precondition to be visualized and presented to the user.

Note that the answer creation unit 44 creates a new answer based on the updated precondition using the generative AI, and the answer output unit 45 transmits the answer information to the user terminal 2 to display the new answer in the dialogue area 35. For instance, the answer creation unit 44 uses the generative AI to create the answer, “Understood. Task B takes about 40 minutes based on past data,” based on the updated precondition, “Task Process A is complete,” based on the updated precondition, "Task Process A is complete.", and the user terminal 2 then displays this text in the dialogue area 35, as illustrated in FIG. 5B.

Note that it is desirable that the time from in a case where the determination unit 43 determines that the dialogue information is information to train the generative AI until the precondition is displayed in the precondition area 36 is short.

By displaying the precondition learned by the generative AI in an area separate from the area displaying the dialogue in this way, the user can easily check the content learned by the generative AI while engaging in the dialogue. Therefore, even if the dialogue context changes, such as across different days or different users, the user can accurately understand the precondition, that is, the content learned by the generative AI, without loss of time. For instance, in the case illustrated in FIG. 4, workers B and C can immediately grasp the new precondition "Task A process completed" added through the dialogue with worker A, simply by looking at the precondition area 36 on the screen.

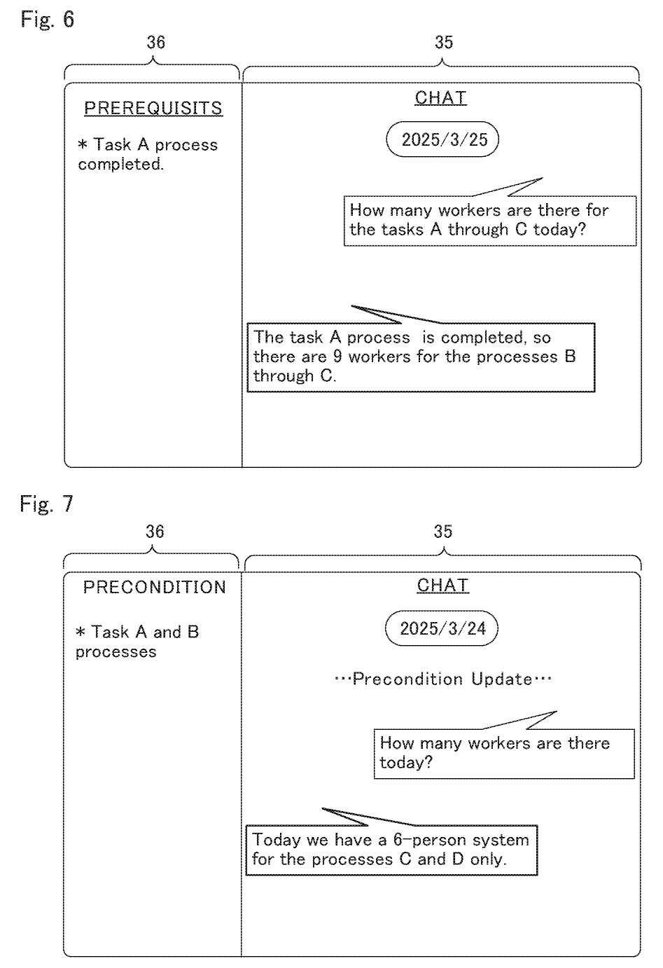

FIG. 6 is an example of a screen on a different date. Specifically, FIG. 6 illustrates an example of the screen that can be viewed by workers A to C on Mar. 25, following Mar. 24, 2025, on which the new precondition was added through a dialogue with the worker A. As illustrated in FIG. 6, even if the date has spanned, the text "Task A process completed" is displayed in the precondition area 36 on the screen. In this way, even if the workers A to C view the screen at a later date, they can easily grasp the content learned by the generative AI up to that point just by looking at the precondition area 36, and the user can engage in dialogue with the generative AI based on that precondition.

The edit information acquisition unit 50 acquires edit information regarding the editing of the precondition by the user from the user terminal 2. In a case where dialogue is shared by multiple users, the editing of the precondition can be performed by all users. The user freely edits the precondition displayed in the precondition area 36 directly using the user terminal 2. The user may edit the precondition by making a request in a chat-based dialogue using the user terminal 2.

FIG. 7 is an example of a screen where the precondition has been edited. For instance, in a case where the precondition "Task A process completed" displayed in the precondition area 36 is edited by the user to "Task A and B processes completed," the user terminal 2 transmits text prior to editing, edited text, and the difference due to editing as edit information to the server 1. Thus, the edit information acquisition unit 50 acquires the edit information from the user terminal 2.

The text analysis unit 51 analyzes the meaning of the edit information by analyzing words, sentence structure, and intent included in the text.

The editing unit 52 edits the precondition stored in the precondition DB 31 based on the analysis result by the text analysis unit 51 and the editing information, and causes the generative AI to learn the edited precondition.

Furthermore, in a case where the precondition learned by the generative AI are edited, the editing unit 52 transmits information to the user terminal 2 indicating that the learning by the generative AI has been updated. Upon receiving information indicating that learning by the generative AI has been updated, the user terminal 2 displays the text “Prerequisite Update” in the dialogue area 35, as illustrated in FIG. 7. This enables the timing at which the generative AI is learning the precondition to be visualized and presented to the user.

Note that the storing unit 48 stores the generative AI model, which has learned the edited preconditions, in the precondition DB 31. At this time, the precondition output unit 49 transmits information organizing all preconditions, including the edited preconditions, to the user terminal 2, causing them to be displayed in a list in the precondition area 36.

In the subsequent dialogue with the user after the edited preconditions are displayed, the answer creation unit 44 creates an answer based on the edited preconditions, and the answer output unit 45 causes the answer to be displayed in the dialogue area of the user terminal 2. For instance, the answer creation unit 44 uses the generative AI to create the answer "Today we have a 6-person system for processes C and D only," as the answer to the user's question "How many workers are there today?" based on the updated precondition "Task A and B processes completed," and the user terminal 2 displays the text in the dialogue area 35, as illustrated in FIG. 7.

In the above configuration, the dialogue information acquisition unit 41, the determination unit 43, the answer creation unit 44, the answer output unit 45, the learning unit 47, the storing unit 48, the precondition output unit 49, the edit information acquisition unit 50, and the editing unit 52 of the server 1 are examples of a dialogue information acquisition means, a determination means, an answer creation means, an answer output means, a learning means, a storing means, a precondition output means, an edit information acquisition means, and an editing means of the present disclosure, respectively. Also, the answer creation unit 44 and the information supplementation unit 46 are examples of the relevant information acquisition means of the present disclosure.

### Prerequisite Output Process

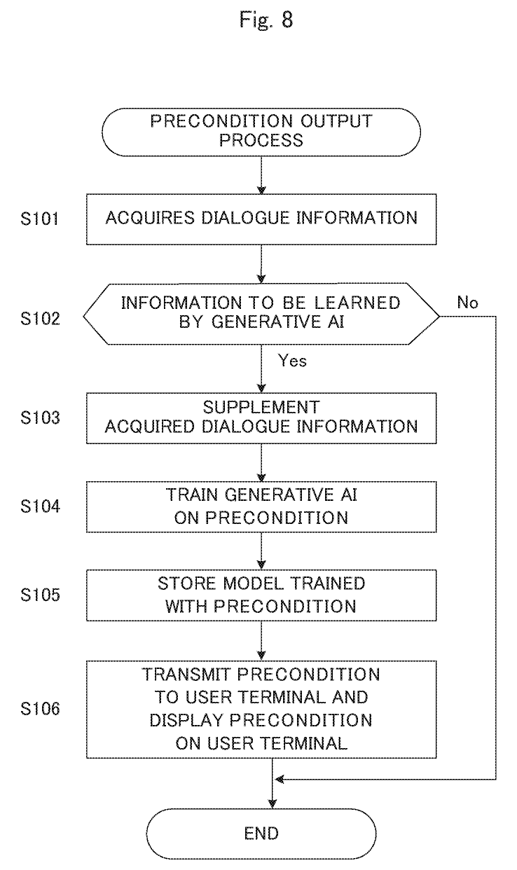

Next, the precondition output process by the server 1 will be described. FIG. 8 is a flowchart illustrating an example of the precondition output process by the server 1. This precondition output process is realized by the processor 12 illustrated in FIG. 2 executing a program prepared in advance.

First, the server 1 acquires dialogue information from the user terminal 2 (step S101). The server 1 determines whether the acquired dialogue information is information to be learned by the generative AI (step S102). If the acquired dialogue information is not information to be learned by the generative AI (step S102; No), the server 1 terminates the precondition output process. On the other hand, if the acquired dialogue information is information to be learned by the generative AI (step S102; Yes), the server 1 supplements the acquired dialogue information (step S103).

Next, the server 1 causes the generative AI to additionally learn the supplemented dialogue information as the precondition (step S104). The server 1 stores the generative AI model, which has been additionally trained with the precondition, in the precondition DB 31 (step S105). The server 1 transmits information indicating that the learning by the generative AI has been updated to the user terminal 2 and causes the text "Prerequisite Updated" to be displayed in the dialogue area 35 of the screen. The server 1 also transmits information regarding all preconditions, including the added preconditions, to the user terminal 2 and causes all preconditions to be displayed in a list in the precondition area 36 of the screen (step S106). After that, the precondition output process is completed.

### Answer Output Process

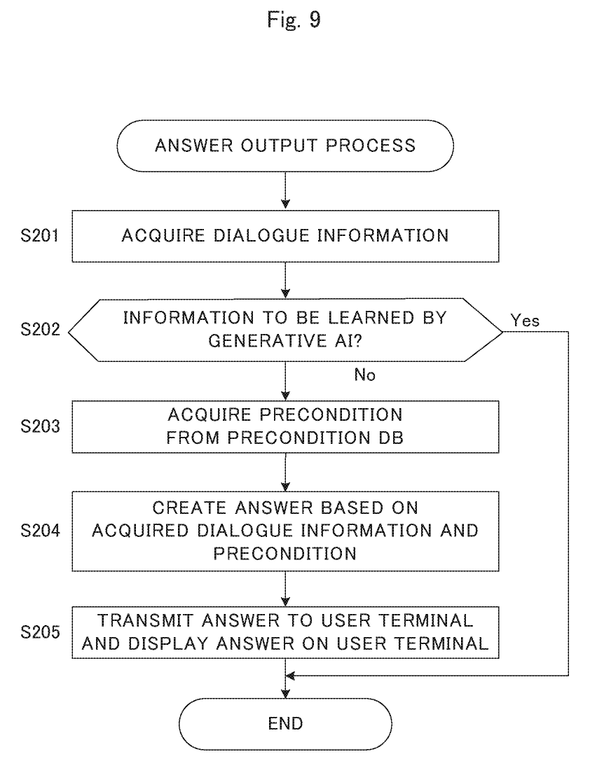

Next, the answer output process by the server 1 will be described. FIG. 9 is a flowchart illustrating an example of the answer output process by the server 1. This answer output process is realized by the processor 12 illustrated in FIG. 2 executing a corresponding program prepared in advance.

First, the server 1 acquires dialogue information from the user terminal 2 (step S201). The server 1 determines whether the acquired dialogue information is information to be learned by the generative AI (step S202). If the acquired dialogue information is information to be learned by the generative AI (step S202; Yes), the server 1 terminates the answer output process. On the other hand, if the acquired dialogue information is not information to be learned by the generative AI (step S202; No), the server 1 acquires the precondition from the precondition DB 31 (step S203). Next, the server 1 uses the generative AI to create an answer based on the acquired dialogue information and precondition (step S204). Subsequently, the server 1 transmits answer information regarding the created answer to the user terminal 2 and causes the answer to be displayed in the dialogue area 35 of the screen (step S205). After that, the answer output process is completed.

Note that in the above answer output process, although the answer output process is terminated in a case where the dialogue information is information to be learned by the generative AI, the present disclosure is not limited thereto, and if the dialogue information is both information to be learned by the generative AI and information requiring the answer, the server 1 performs processes of steps S203 to S205 based on the dialogue information.

### Editing Process

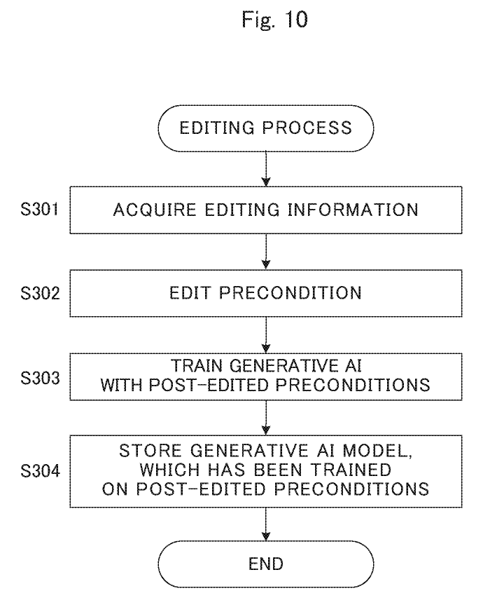

Next, the editing process by the server 1 will be described. FIG. 10 is a flowchart illustrating an example of the editing process by the server 1. This editing process is realized by the processor 12 illustrated in FIG. 2 executing a corresponding program prepared in advance.

First, the server 1 acquires editing information from the user terminal 2 (step S301). The server 1 edits the preconditions stored in the precondition DB 31 based on the acquired editing information (step S302). Next, the server 1 causes the generative AI to learn the edited preconditions (step S303). The server 1 stores the generative AI model, which has been trained on the edited preconditions, in the precondition DB 31 (step S304). The server 1 transmits information to the user terminal 2 indicating that the learning by the generative AI has been updated, and causes the text "Prerequisite condition updated" to be displayed in the dialogue area 35 of the screen. After that, the editing process is completed.

According to the learning content visualization system 100, in a case where multiple users in different environments engage in dialogue using the same generative AI, the preconditions displayed in a list on the screen allow them to instantly grasp the learning content of the generative AI, thereby eliminating discrepancies in understanding. In other words, the next user can take over the content exchanged by the previous user without burden. Furthermore, since the user can easily understand learning contents of the generative AI, it is possible to improve the reliability of the answer as an output result.

### MODIFICATION EXAMPLE

The learning content visualization system 100 is not limited to an environment that utilizes only closed data based on dialogue information as the precondition; it can also be applied to an environment that utilizes open data, such as "national standards," as preconditions.

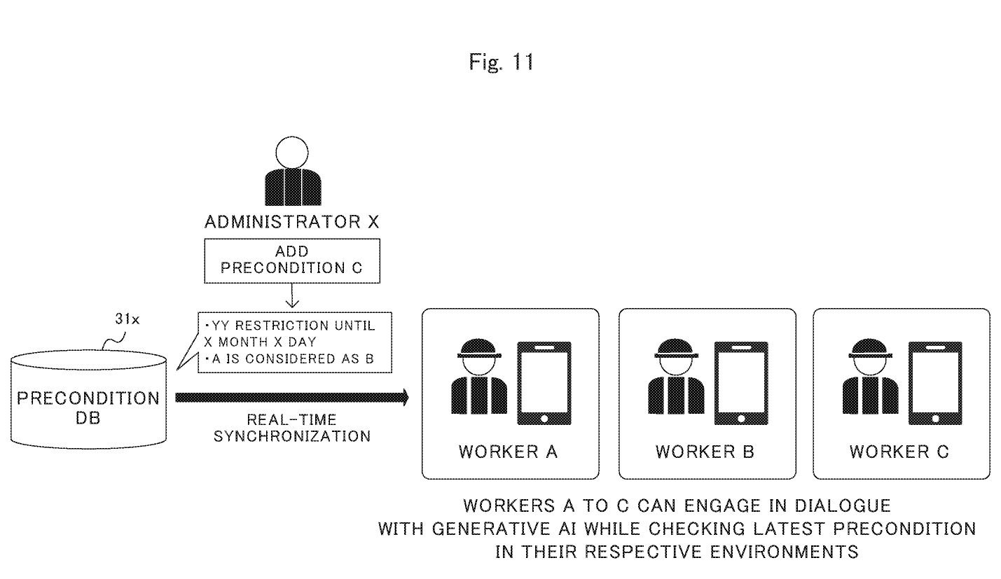

FIG. 11 is a diagram illustrating a process performed by the learning content visualization system 100 in an open environment. As an example, a learning content visualization system 100 in FIG. 11 includes an open precondition database 31x managed by an administrator X, and is configured as a system in which workers A to C each conduct dialogues with the generative AI in their respective environments using their respective user terminals.

In this case, the administrator X can add or edit preconditions, and the precondition area 36 on the screen of the user terminal used by each of the workers A to C is updated in real time whenever the preconditions are updated. That is, the latest preconditions are always displayed in a list in the precondition area 36 on the user terminal used by each of the workers A to C. It is possible for the workers A to C to perform work confirmation and ask questions through the dialogue with the generative AI while checking the latest precondition.

### SECOND EXAMPLE EMBODIMENT

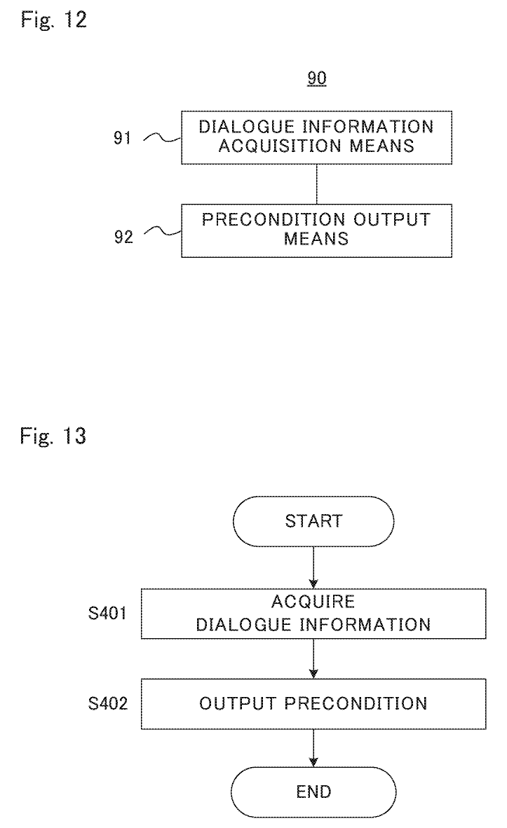

FIG. 12 is a block diagram illustrating an example of another functional configuration of the information processing device in the present disclosure. An information processing device 90 includes a dialogue information acquisition means 91 and a precondition output means 92.

FIG. 13 is a flowchart illustrating an example of a process performed by the information processing device 90. The information processing device 90 includes the generative AI and is communicably connected to a terminal device used by a user who dialogues with the generative AI. The dialogue information acquisition means 91 acquires dialogue information regarding the dialogue content input by the user from the terminal device (step S401). The precondition output means 92 transmits the preconditions learned by the generative AI based on the dialogue information to the terminal device, and causes the preconditions to be displayed on the terminal device in an area different from the area displaying the dialogue content (step S402). In other words, the precondition output means 92 outputs the preconditions. The information processing device 90 makes it possible to visualize, in an easily understandable manner for the user, contents learned by the generative AI in the system utilizing the interactive generative AI.

In addition, Additionally, some or all of the above example embodiments (including the modification example, the same applies below) may also be described as follows, but are not limited to the following.

### Supplementary Note 1

An information processing device including:
a generative AI;
a dialogue information acquisition means, configured to be communicably connected to a terminal device used by a user who engages in dialogue with the generative AI, and to acquire, from the terminal device, dialogue information relating to dialogue content input by the user; and
a precondition output means, configured to transmit, based on the dialogue information, at least one precondition learned by the generative AI to the terminal device, and to cause the terminal device to display the precondition in an area different from an area in which the dialogue content is displayed.

### Supplementary Note 2

The information processing device according to Supplementary Note 1, further including:
an edit information acquisition means configured to acquire, from the terminal device, edit information relating to editing of the precondition by the user; and
an editing means configured to edit the precondition based on the edit information and to cause the generative AI to learn the edited precondition.

### Supplementary Note 3

The information processing device according to Supplementary Note 1, further including:
a determination means configured to determine whether the dialogue information is information to be learned by the generative AI;
a learning means configured to cause the generative AI to learn the dialogue information determined to be information to be learned as the precondition; and
a storing means configured to store the precondition learned by the generative AI.

### Supplementary Note 4

The information processing device according to Supplementary Note 1, further including:
an answer generation means configured to generate an answer in the dialogue with the user based on the dialogue information and the precondition;
an answer output means configured to transmit answer information relating to the answer to the terminal device and to cause the terminal device to display the answer in an area in which the dialogue content is displayed; and
a relevant information acquisition means configured to acquire related information concerning the dialogue based on the precondition;
wherein the answer generation means generates the answer with reference to the related information.

### Supplementary Note 5

The information processing device according to Supplementary Note 4, wherein the relevant information acquisition means generates a prompt including the precondition and acquires the relevant information based on the prompt.

### Supplementary Note 6

The information processing device according to Supplementary Note 1, wherein in a case where the precondition learned by the generative AI is updated, the precondition output means organizes the updated precondition and causes the terminal device to display the updated precondition in a list.

### Supplementary Note 7

The information processing device according to Supplementary Note 1, wherein the precondition output means causes the terminal device to display the precondition learned by the generative AI on the same screen as the area in which the dialogue content is displayed, and in an area different from that area.

### Supplementary Note 8

The information processing device according to Supplementary Note 3, wherein the storing means stores the model of the generative AI in which the precondition has been learned.

### Supplementary Note 9

An information processing method executed by an information processing device including a generative AI and communicably connected to a terminal device used by a user who engages in dialogue with the generative AI, the method including:
acquiring, from the terminal device, dialogue information relating to dialogue content input by the user; and
transmitting, based on the dialogue information, at least one precondition learned by the generative AI to the terminal device, and causing the terminal device to display the precondition in an area different from an area in which the dialogue content is displayed.

### Supplementary Note 10

A program executed by a computer of an information processing device including a generative AI and communicably connected to a terminal device used by a user who engages in dialogue with the generative AI, the program causing the computer to perform:
acquiring, from the terminal device, dialogue information relating to dialogue content input by the user; and
transmitting, based on the dialogue information, at least one precondition learned by the generative AI to the terminal device, and causing the terminal device to display the precondition in an area different from an area in which the dialogue content is displayed.

### Supplementary Note 11

The information processing device according to Supplementary Note 3, wherein the edit information acquisition means acquires edit information relating to editing performed via input to the area in which the precondition is displayed.

### Supplementary Note 12

The information processing device according to Supplementary Note 3, wherein editing of the precondition can be performed by a user different from the user who engaged in dialogue regarding the precondition.

Furthermore, some or all of the configurations described in Supplementary Notes 2 to 8, 11, and 12 dependent on the above-described Supplementary Note 1 can also be dependent on Supplementary Notes 9 and 10 by the same dependency relationship as in Supplementary Notes 2 to 8, 11, and 12. Moreover, some or all of the configurations described as Supplementary Notes can be similarly dependent on not only Supplementary Notes 1, 9, and 10, but also various pieces of hardware and software, and various recording means or systems for recording software without departing from the above-described example embodiments.

Although the present disclosure has been described with reference to the example embodiments above, the present disclosure is not limited to these example embodiments. Various changes understandable by those skilled in the art can be made to the configuration and details of the present disclosure within the scope of the present disclosure. In other words, the present disclosure naturally includes various modifications and alterations that would be conceivable to those skilled in the art in accordance with the entire disclosure, including the claims, and the technical concept.

### DESCRIPTION OF SYMBOLS

1 Server
2 User terminal
11, 21 Interface
12, 22 Processor
13, 23 Memory
14, 24 Recording medium
15, 25 Display unit
16, 26 Input unit
31 Precondition DB
41 Dialogue information acquisition unit
42, 51 Text analysis unit
43 Determination unit
44 Answer creation unit
45 Answer output unit
46 Information supplementation unit
47 Learning unit
48 Storing unit
49 Precondition output unit
50 Edit information acquisition unit
52 Editing unit
100 Learning content visualization system

1. An information processing device including a generative AI and communicably connected to a terminal device used by a user who engages in dialogue with the generative AI, the information processing device comprising:
at least one memory configured to store instructions; and
at least one processor configured to execute the instructions to:
acquire, from the terminal device, dialogue information relating to dialogue content input by the user; and
transmit, based on the dialogue information, at least one precondition learned by the generative AI to the terminal device, and cause the terminal device to display the precondition in an area different from an area in which the dialogue content is displayed.

2. The information processing device according to claim 1, wherein the processor is further configured to:
acquire, from the terminal device, edit information relating to editing of the precondition by the user; and
edit the precondition based on the edit information and to cause the generative AI to learn the edited precondition.

3. The information processing device according to claim 1, wherein the processor is further configured to:
determine whether the dialogue information is information to be learned by the generative AI;
cause the generative AI to learn the dialogue information determined to be information to be learned as the precondition; and
store the precondition learned by the generative AI.

4. The information processing device according to claim 1, wherein the processor is further configured to:
generate an answer in the dialogue with the user based on the dialogue information and the precondition;
transmit answer information relating to the answer to the terminal device and to cause the terminal device to display the answer in an area in which the dialogue content is displayed; and
acquire related information concerning the dialogue based on the precondition;
wherein the processor generates the answer with reference to the related information.

5. The information processing device according to claim 4, wherein the processor generates a prompt including the precondition and acquires the relevant information based on the prompt.

6. The information processing device according to claim 1, wherein in a case where the precondition learned by the generative AI is updated, the processor organizes the updated precondition and causes the terminal device to display the updated precondition in a list.

7. The information processing device according to claim 1, wherein the processor causes the terminal device to display the precondition learned by the generative AI on the same screen as the area in which the dialogue content is displayed, and in an area different from that area.

8. The information processing device according to claim 3, wherein the processor stores the model of the generative AI in which the precondition has been learned.

9. An information processing method executed by an information processing device comprising a generative AI and communicably connected to a terminal device used by a user who engages in dialogue with the generative AI, the method comprising:
acquiring, from the terminal device, dialogue information relating to dialogue content input by the user; and
transmitting, based on the dialogue information, at least one precondition learned by the generative AI to the terminal device, and causing the terminal device to display the precondition in an area different from an area in which the dialogue content is displayed.

10. A non-transitory computer-readable recording medium storing a program executed by a computer of an information processing device comprising a generative AI and communicably connected to a terminal device used by a user who engages in dialogue with the generative AI, the program causing the computer to perform:
acquiring, from the terminal device, dialogue information relating to dialogue content input by the user; and
transmitting, based on the dialogue information, at least one precondition learned by the generative AI to the terminal device, and causing the terminal device to display the precondition in an area different from an area in which the dialogue content is displayed.
